(19) United States
(12) Patent Application Publication
(10) Pub. No.: US 2003/0225669 A1
(43) Pub. Date: Dec. 4, 2003

(54) Method of conducting an auction

(76) Inventor: Josh Cohen, Valhalla, NY (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/160,325

(22) Filed: May 31, 2002

(51) Int. Cl. G06F 17/60

(52) U.S. Cl. 705/37

(57) ABSTRACT

The present invention provides a method for conducting an auction in which an individual's time is monetized for bidding purposes. The inventive method generally includes the steps of providing a plurality of auction items upon which bidders may bid, and accepting bids from various bidders on the plurality of auction items. In accordance with the present invention, the bids include amounts of service hours that a bidder will work for one or more of a plurality of preselect organizations. Additionally, the bid service hours of work must be performed within a preselect period of time, e.g., one year. At the conclusion of the auction, the auction items are awarded to respective bidders that bid the highest amount of service hours for each respective auction item. The highest bidder is only presented with its respective auction item if he or she completes the amount of service hours of work he or she bids in the preselect period of time. If the highest bidder does not complete the bid service hours of work in the preselect period of time, the next highest bidder for that auction item is given the opportunity to perform their bid amount of service hours of work within a new preselect period of time, e.g., one year, in order to receive the auction item.

### FIELD OF THE INVENTION

The present invention is directed toward a method of conducting an auction and, more particularly, toward a method of conducting an auction in which an individual's time is monetized and utilized as the bidding medium.

### BACKGROUND OF THE INVENTION

Auctions are typically conducted to generate revenue for various purposes and/or organizations. Auctions may be conducted on a live, silent or online basis, or any combination of the three. Auctions may be held for charitable or non-profit purposes, as well as for commercial for-profit ventures.

With regard to charitable auctions, items are typically donated to an auction sponsor. The auction sponsor then arranges to conduct an auction at a predetermined location and time, at which the donated items will be auctioned off to the highest bidder. Individuals either interested in the items to be auctioned off and/or the charitable purpose or organization associated with the auction typically will attend the auction and monetarily bid on the various donated items. Typically, the auction sponsor will retain a percentage of the monies generated by the auction, with the charitable purpose or organization associated with the auction receiving the rest.

In an auction held on a for-profit basis, items are provided to an auction sponsor who arranges to have the items auctioned off. Individuals interested in the items will attend the auction and monetarily bid on them, with the highest bidders receiving the items. The auction sponsor will typically retain a percentage of the selling price of each item, with the remaining money going to the individual or other entity who provided each item to be auctioned off.

In a silent auction, the items to be auctioned off are typically made available to the prospective bidders for inspection purposes. If the item is unable to be made available, such as in the case of a vacation or a service, a description of the item is typically provided. Bids on the items are then made by the bidders by writing their names and bid amounts on a bid sheet that is associated with the item. If the bidding is to be done on an anonymous basis, each bidder is provided with a unique bid code which is written on the bid sheet instead of their name. At the end of the auction, the bid sheets are collected and highest bidder for each item is determined and is announced as the respective winner of that item. The winner then pays for the item using cash, check, credit card, etc., and is presented with the item.

In the case of a live auction, the winning bid for the auction items are typically determined by a dialog between an auctioneer and the bidders. The dialog may be a verbal dialog with the bidder verbally announcing a price that he or she will bid, or via cards or other means held up by a bidder indicating that he or she has accepted the auctioneer's verbally announced bid amount. Once no more bids are solicited by an auctioneer, or announced by the bidders, the bidding is finalized and the auctioneer awards the auction item to the bidder who has bid the highest amount. The highest bidder then pays for the item using cash, check, credit card, etc., and is presented with the auction item.

Online auctions may be silent or live, or any combination of the two. Bidders can view the auction items, or a description thereof, from a convenient location (home, office, etc.) via a computer network. Bidders submit bids to the auction sponsor via the computer network, and at the end of the auction the auction items are awarded to the highest bidder. Typically, the bidder will use a credit card to pay for the item and will receive it shortly after the auction.

In all auctions, whether live, silent or online, typically it is the richest bidders who will have the advantage as they will more readily be able to afford paying higher prices for the auction items they want. Thus, richer bidders can simply force the other bidders out of the bidding war by bidding more than the other bidders can afford.

The present invention is directed toward overcoming one or more of the above-mentioned problems.

### SUMMARY OF THE INVENTION

The present invention provides a method for conducting an auction in which an individual's time is monetized for bidding purposes. The inventive method generally includes the steps of providing a plurality of auction items upon which bidders may bid, and accepting bids from various bidders on the plurality of auction items. In accordance with the present invention, the bids include amounts of service hours that a bidder will work for one or more of a plurality of preselect organizations. Additionally, the bid service hours of work must be performed within a preselect period of time, e.g., one year. At the conclusion of the auction, the auction items are awarded to respective bidders that bid the highest amount of service hours for each respective auction item. The highest bidder is only presented with its respective auction item if he or she completes the amount of service hours of work he or she bid in the preselect period of time. If the highest bidder does not complete the bid service hours of work in the preselect period of time, the next highest bidder for that auction item is given the opportunity to perform their bid amount of service hours of work within a new preselect period of time, e.g., one year, in order to receive the auction item.

The highest bidder may allocate its bid service hour amount between one or more of the plurality of preselect organizations. Thus, bidders are bidding flat service hour amounts for the auction items.

In one form, the service hours that are bid include volunteer work hours that a bidder will work performing volunteer work for one or more of a plurality of preselect charitable organizations.

In another form, at the conclusion of the auction, each respective highest bidder will allocate its bid service hour amount between one or more of the plurality of preselect organizations and assume a contractual obligation to perform its bid service hours of work within the preselect period of time. If the highest bidder does not wish to assume this contractual obligation, then the auction item will be awarded to the next highest bidder who can then allocate its bid service hour amount and assume the contractual obligation.

The contractual obligation may include a financial penalty. In yet another form, the financial penalty is equal to the average hourly rate of temporary personnel multiplied by the number of allocated bid service hours of work not performed by the highest bidder. This financial penalty may be utilized by the respective organization(s) to hire temporary personnel to complete the allocated amount of service hours of work.

The auction may include a live, silent or online auction, or any combination of the three, and while typically contemplated for use by charitable purposes or organizations, may also be utilized for commercial for-profit ventures.

It is general object of the present invention to provide a method of conducting an auction in which an individual's time is monetized for bidding purposes.

### BRIEF DESCRIPTION OF THE DRAWINGS

FIGS. 1A and 1B are a flowchart illustrating a method of conducting an auction according to the present invention.

### DETAILED DESCRIPTION OF THE INVENTION

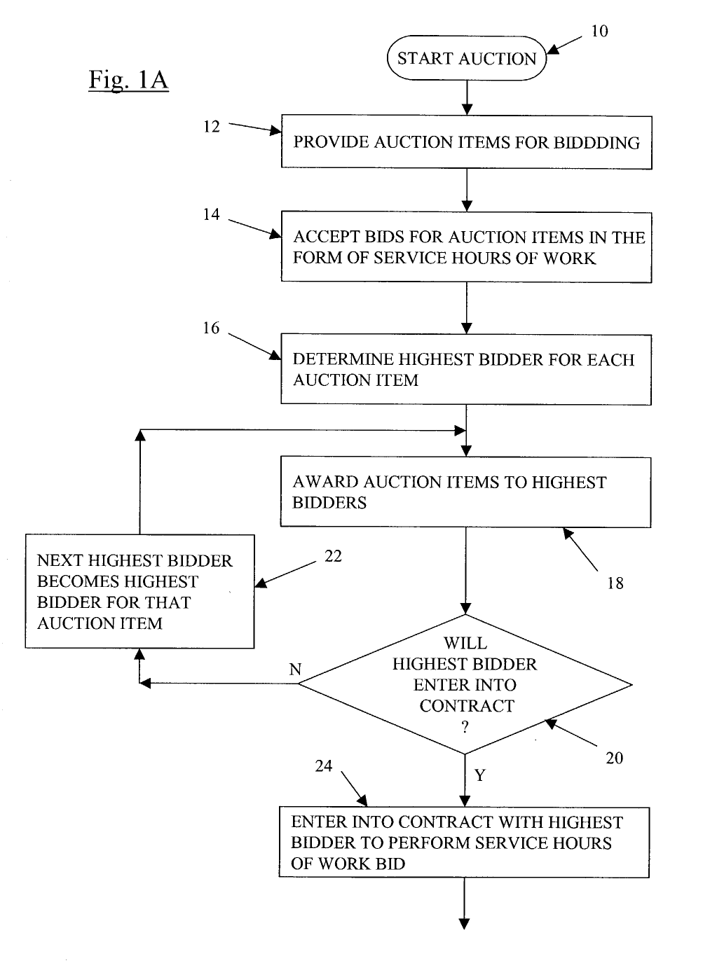

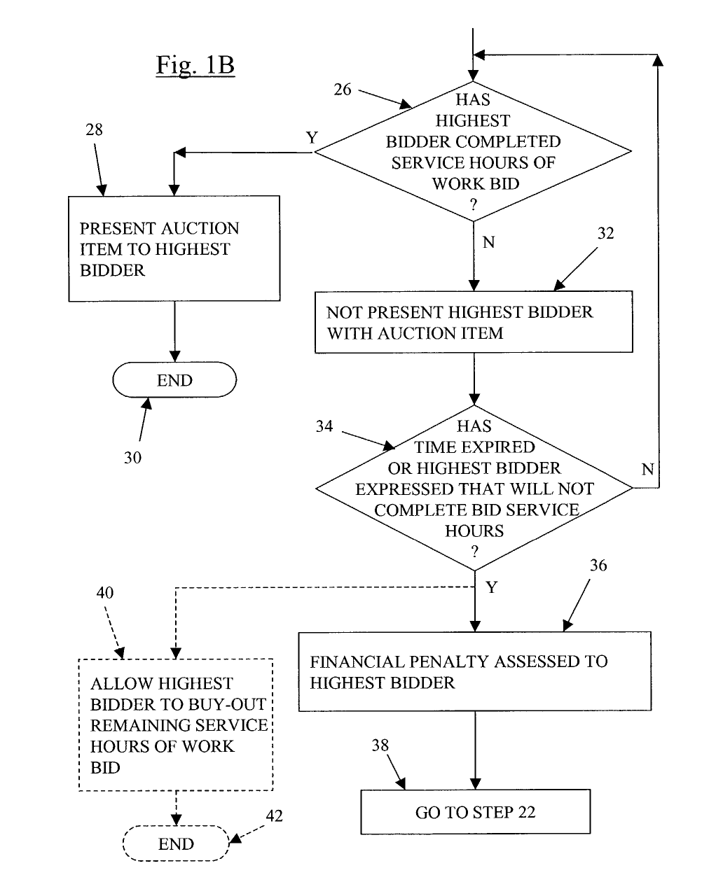

The present invention provides a method for conducting an auction in which an individual's time is monetized for bidding purposes. The method of the present invention offers a more even bidding scale for individuals desiring to bid on select auction items. The operation of the inventive method will now be described with reference to the flow chart of FIGS. 1A and 1B.

At step 10, the sponsor of the auction will initiate the beginning of the auction. The auction sponsor will provide a plurality of auction items which may be bid upon by prospective bidders attending the auction (at step 12). Typically, for charitable auctions, the auction items will be donated by local businesses in the area. The auction items may include prizes or services donated by local businesses in the area and may include, but are not limited to, tangible items, such as, TVs, motorcycles, cars, appliances, furniture, etc., vacations, trips, sporting event tickets, amusement park admission tickets, dates with local celebrities, various types of services, or any other type of item that may be auctioned off. In an auction held for-profit, the auction items will typically be provided by the entity or entities desiring to reap the benefits of the auction.

The auction sponsor then accepts bids for the various auction items (at step 14), with the bids being in the form of service hours of work that an individual is willing to perform in order to receive the auction item. The service hours of work may be performed at one preselect organization, or one or more of a plurality of preselect organizations. The service hours of work are bid with the understanding that they must be completed within a preselect period of time, e.g., one year. However, other longer or shorter time periods may be used as long as they are communicated to the bidders before the bidding begins. Additionally, different preselect time periods may be utilized for different auction items. The bids may be accepted via a live auction, in which a dialog is generated between the bidders and an auctioneer, or by a silent auction in which the bidders write down their bid amounts of service hours on a bid sheet along with their name or ID code. Additionally, the bids may be accepted via online auctions utilizing either a live or silent auction basis, or any combination of the two, without departing from the spirit and scope of the present invention. The highest bidder is then determined for each auction item (at step 16), and the auction items are awarded to the highest bidders (at step 18). The highest bidders determined at step 16 are those who bid the highest amount of service hours for each auction item.

Each of the highest bidders will be required to enter into a contract in which the highest bidder will assume a contractual obligation to perform its bid service hours of work within the preselect period of time. If, at step 20, the highest bidder is unwilling to enter into such a contract, the next highest bidder will become the highest bidder for that particular auction item (at step 22). The inventive method then proceeds back to step 18 and proceeds as previously described utilizing the next highest bidder as the highest bidder.

Additionally, the highest bidder may be responsible for any taxes that may be payable on the auction item. For example, where the auction item is a $5,000 motorcycle, the highest bidder may still have to pay taxes on the auction item. Where taxes are due, typically bidders are made aware of the taxes prior to bidding. In this case, bidding essentially begins at “taxes+one hour”. Where appropriate, the contract may include a provision relating to the highest bidder's responsibility for such taxes. Alternately, the contract may provide for a deduction in the amount of bid service hours of work as a form of compensation for the tax responsibility.

If the highest bidder agrees to enter into the contract, at step 20, a contract is entered into with the highest bidder in which the highest bidder assumes a contractual obligation to perform its bid service hours of work (at step 24). Additionally, as part of the contract and if the auction permits, the highest bidder may allocate its bid amount of service hours of work between one or more of a plurality of preselect organizations. The contract may be entered into between the highest bidder and the auction sponsor, or directly between the highest bidder and the organization(s) which is to receive service hours of work from the highest bidder.

The contractual obligation assumed by the highest bidder may include a financial penalty for not performing the bid amount of service hours of work. The financial penalty may be equal to the average hourly rate of manpower temporary personnel in the geographical area of the highest bidder, and/or the respective organization to which the highest bidder has agreed to perform service hours of work, multiplied by the number of bid or allocated service hours of work not performed by the highest bidder for the respective organization.

As previously noted, as part of the contractual obligation, the highest bidder may allocate to one or more of a plurality of preselect organizations a number of the bid service hours of work he or she will perform for those particular organizations. Provided below, and for exemplary purposes only, is one example of how the financial penalty may be realized in the case of a charitable auction.

Presently, for charitable auctions, the auction sponsor is contemplated as being Developing Minds, which is 501(c)(3) corporation in both Arizona and California. For charitable auctions, the service hours that are bid, at step 14, include volunteer work hours that a bidder will work performing volunteer work for one preselect, or one or more of a plurality of preselect, charitable organizations. The preselect organizations at which a bidder may perform volunteer work are contemplated as being the current partners of Developing Minds at the time of the auction. However, if agreed to between Developing Minds and the highest bidder (assuming the contract to perform services is between the highest bidder and Developing Minds), the plurality of preselect charitable organizations may be changed from time to time without departing from the spirit and scope of the present invention. The previously described financial penalty incurred by the highest bidder for failure to perform the agreed hourly amount of volunteer work may be utilized by the respective organizations to hire temporary personnel to complete the allocated amount of volunteer work. In this particular scenario, the financial penalty works as follows.

Assume the highest bidder has bid 100 volunteer work hours for a particular auction item. In entering into the contract, at step 24, the highest bidder allocates their volunteer work hours as follows: 25 hours to be performed at Organization A; 25 hours to be performed at Organization B; and 50 hours to be performed at Organization C. At the end of the preselect period of time (e.g., one year), the highest bidder has performed 25 hours of volunteer work at Organization A, 25 hours of volunteer work at Organization B, and only 40 hours of volunteer work at Organization C. Thus, at the expiration of the preselect period of time, the highest bidder will not be presented with the auction item and will be assessed a financial penalty equal to the average hourly rate of manpower temporary personnel in the geographical area of the highest bidder, and/or Organization C, multiplied by 10 hours (the number of volunteer work hours not completed at Organization C). This financial penalty will be presented to Organization C so that it may hire temporary personnel to complete the allocated amount of volunteer work hours or otherwise use the money as it sees fit.

In the above example, the contract would most likely be entered into between the auction sponsor, e.g., Developing Minds, and the highest bidder. As the highest bidder completes its volunteer work hours at each organization, the volunteer managers at each organization, or their respective designees, sign off that the volunteer work hours were completed. It should be understood that the above example may also be implemented with for-profit organizations without departing from the spirit and scope of the present invention. Additionally, the highest bidder may contractly directly with each organization that is to receive his or her services. Such a direct contract is easy to implement when only one organization is receiving services from the highest bidder. However, where the bid service hours are allocated between multiple organizations, it may be beneficial to have one entity (e.g., auction sponsor or other entity) contract with the highest bidder and/or monitor that all of the bid service hours of work have been completed before presenting the prize to the highest bidder.

After the highest bidder has entered into the contract, at step 24, the inventive method proceeds to step 26 at which it is determined whether the highest bidder has completed his or her bid service hour amount of work. If the highest bidder has completed its bid service hour amount of work, the auction item is presented to the highest bidder (at step 28) and the auction method ends, at step 30. If it is determined, at step 26, that the highest bidder is not completed its bid service hour amount of work, the highest bidder is not presented with the auction item (at step 32) and it is determined whether the preselect period of time has expired or the highest bidder has expressly indicated that he or she will not complete the bid service hour amount of work (at step 34). If the answer at step 34 is no, the inventive method proceeds back to step 26 where it is determined whether or not the highest bidder has completed its bid service hour amount of work. The inventive method continues in a loop between steps 26, 32 and 34 until the answer at steps 26 or 34 is a yes.

If the answer at step 34 is yes, a financial penalty, which may be the financial penalty previously described, is assessed against the highest bidder (at step 36) and the inventive method proceeds back to step 22 (at step 38) wherein the next highest bidder becomes the highest bidder for that auction item. The inventive method then proceeds as previously described utilizing the next highest bidder for the highest bidder.

In the event that the auction item is presented to the highest bidder before the expiration of the preselect period of time, for example, where the auction item includes tickets to a specific event which occurs within the preselect period of time, the financial penalty is assessed to the highest bidder, at step 36, for failure to complete its bid amount of service work hours, and the method ends since the auction item cannot be offered to the next highest bidder.

If the highest bidder cannot complete its bid amount of service hours of work due to sickness or death, the auction item, and hence the contractual obligation, may be transferred and the transferee can complete the remaining bid amount of service hours of work and be presented with the auction item. Alternately, the highest bidder can designate someone to perform or complete the bid amount of service hours of work, and the highest bidder would still be presented with the auction item at the completion thereof.

Additionally, there may be cases where the highest bidder may elect to pay in cash the equivalent value of their remaining hours of service. This can only be done, however, with the consent of the auction sponsor or organization(s) with which the highest bidder has contracted. In this alternate form, shown in dotted lines in FIG. 1B, if it is determined, at step 34, that the preselect period of time has expired or the highest bidder has expressly indicated the ho or she will not complete the bid service hour amount of work, the highest bidder may elect to buy-out the remaining service hours of work bid (at step 40) and receive the auction item. The buy-out may be based on: (a) the equation “bid time=value of the auction item”; (b) the average cost of hiring temporary manpower personnel per geography as previously described for the financial penalty; or (c) any other formula or amount agreed to with the highest bidder. After the highest bidder buys-out his or her remaining service hours of work, they are presented with the auction item and the method ends, at step 42.

The equation “bid time=value of the auction item” can only be used if the auction item has a set value amount. The set value amount of the auction item may be divided by the number of service hours bid to arrive at a dollar amount per service hour of work figure. The remaining service hours of work may simply be multiplied by this dollar-per-hour figure to determine the highest bidder's buy-out amount. However, other calculations or formulas may be used to calculate a dollar value of each service hour worked which would be deducted from the value amount of the auction item to determine a buy-out amount.

While the present invention has been described with particular reference to the drawings, it should be understood that various modifications could be made without departing from the spirit and scope of the present invention. For example, and particularly unique to the Internet, the auction items may include various projects, such as, IT projects, accounting projects, etc., offered by various companies which are willing to pay a set amount to have work performed on the respective project. Consultants and other individuals may bid the amount of hours they are willing to work on the project in return for the set amount. The company would then choose the bidder who bid the highest hourly amount and contract with the bidder to have the bid amount of hours performed on the project. After the highest bidder works the bid amount of hours on the project, the highest bidder would then receive the set amount paid by the company. Alternatively, the company may contract and pay the highest bidder on a prorated basis for work performed. Additionally, the contract may provide for a financial penalty to the highest bidder in the event that the highest bidder does not complete the bid amount of service hours. As previously described, the financial penalty may be the cost to the company of obtaining manpower to complete the bid number of hours that the highest bidder had bid on the project.

Additionally, where auction item includes services to be received by the highest bidder, the highest bidder would only begin to receive the services after its bid service hour amount of work has been performed. For example, the highest bidder may receive a year of free lawn care, a year of free oil changes, free gas for a set amount of time, etc., which only begins after completion of the bid service hour amount of work.

Further, while the financial penalty has been described herein as being the cost of hiring temporary personnel to complete the bid service hours of work, any type of penalty, financial or otherwise, may be agreed to in the contract as the contractual obligation without departing from the spirit and scope of the present invention.

I claim:

1. A method of conducting an auction comprising the steps of:
providing an auction item upon which bidders may bid;
accepting bids from bidders on the auction item, wherein the bids comprise amounts of service hours that a bidder will work for at least one preselect organization;
awarding the auction item to the bidder that bid the highest amount of service hours; and
presenting the auction item to the highest bidder only after the highest bidder has completed the highest amount of service hours of work bid.

2. The method of claim 1, wherein the highest bidder has a preselect period of time in which to complete the highest amount of service hours of work bid, wherein if the highest bidder does not complete the highest amount of service hours of work bid in the preselect period of time the highest bidder will not be presented with the auction item.

3. The method of claim 2, further comprising the steps of:
if the highest bidder does not complete the highest amount of service hours bid in the preselect period of time,
awarding the auction item to the bidder that bid the next highest service hour amount;
providing the next highest bidder with a new preselect period of time in which to complete the next highest amount of service hours of work bid; and
presenting the auction item to the next highest bidder only if the next highest bidder completes the next highest amount of service hours of work bid in the new preselect period of time.

4. The method of claim 2, wherein the preselect period of time comprises one year.

5. The method of claim 2, further comprising the step of contracting with the highest bidder, wherein the highest bidder assumes a contractual obligation to perform the highest amount of service hours of work bid within the preselect period of time.

6. The method of claim 5, wherein the contractual obligation comprises a financial penalty equal to an average hourly rate of manpower temporary personnel multiplied by a number of the highest amount of service hours of work bid for which the highest bidder has not performed work within the preselect period of time.

7. The method of claim 1, further comprising the step of providing the highest bidder with the opportunity to allocate the highest amount of service hours of work bid between one or more of a plurality of preselect organizations.

8. The method of claim 7, further comprising the step of contracting with the highest bidder, wherein the highest bidder allocates the highest amount of service hours of work bid between one or more of the plurality of preselect organization, and assumes a contractual obligation to perform the highest amount of service hours of work bid within a preselect period of time, and
wherein the contractual obligation comprises a financial penalty equal to an average hourly rate of manpower temporary personnel in a geographical area of the highest bidder and/or a respective organization to which the highest bidder has allocated service hours of work bid multiplied by a number of the allocated highest amount of service hours of work bid for which the highest bidder has not performed work for the respective organization.

9. The method of claim 1, wherein the auction comprises a live, silent or online auction.

10. The method of claim 1, wherein the at least one preselect organization comprises at least one preselect charitable organization, and wherein the service hours that are bid comprise volunteer work hours that a bidder will work performing volunteer work for the at least one preselect charitable organization.

11. The method of claim 1, further comprising the step of:
if the highest bidder does not complete the highest amount of service hours bid in the preselect period of time,
allowing the highest bidder to buy-out remaining hours from its highest amount of service hours bid for which work has not been performed in order to complete the highest amount of service hours of work bid,
wherein the buy-out includes paying a cash value determined for the remaining hours.

12. A method of conducting an auction comprising the steps of:
providing a plurality of auction items upon which bidders may bid;
accepting bids from bidders on the plurality of auction items, wherein the bids comprise amounts of service hours that a bidder will work for at least one preselect organization within a preselect period of time;
awarding the plurality of auction items to respective bidders that bid the highest amount of service hours for each respective auction item; and
presenting each respective auction item to its respective highest bidder only if the respective highest bidder completes the highest amount of service hours of work bid for the at least one preselect organization within the preselect period of time.

13. The method of claim 12, wherein the auction comprises a live, silent or online auction.

14. The method of claim 12, further comprising the step of contracting with each respective highest bidder, wherein each respective highest bidder allocates its highest bid amount of service hours of work bid between the at least one preselect organization and assumes a contractual obligation to perform its highest amount of service hours of work bid within the preselect period of time.

15. The method of claim 14, wherein the contractual obligation comprises a financial penalty equal to an average hourly rate of manpower temporary personnel in a geographical area of a respective highest bidder and/or a respective organization to which the respective highest bidder has allocated service hours of work bid multiplied by a number of the allocated highest amount of service hours of work bid for which the respective highest bidder has not performed work for the respective organization.

16. The method of claim 15, wherein the financial penalty is used by each respective organization at which the respective highest bidder has not completed the allocated amount of service hours of work bid to hire temporary personnel to complete the allocated amount of service hours of work bid.

17. The method of claim 12, further comprising the steps of:
if the respective highest bidder does not complete the highest amount of service hours of work bid in the preselect period of time,
awarding the auction item to the bidder that bid the next highest service hour amount for the respective auction item;
providing the respective next highest bidder with a new preselect period of time in which to complete the next highest amount of service hours of work bid; and
presenting the respective auction item to the respective next highest bidder only if the respective next highest bidder completes the next highest amount of service hours of work bid in the new preselect period of time.

18. The method of claim 17, further comprising the step of contracting with each respective next highest bidder, wherein each respective next highest bidder allocates its next highest amount of service hours of work bid between the at least one preselect organization and assumes a contractual obligation to perform its next highest amount of service hours of work bid within the new preselect period of time.

19. The method of claim 18, wherein the contractual obligation comprises a financial penalty equal to an average hourly rate of manpower temporary personnel in a geographical area of the respective next highest bidder and/or a respective organization to which the respective next highest bidder has allocated service hours of work bid multiplied by a number of the allocated next highest amount of service hours of work bid for which the respective next highest bidder has not performed work for the respective organization.

20. The method of claim 19, wherein the financial penalty is used by each respective organization at which the respective next highest bidder has not completed the allocated amount of service hours of work bid to hire temporary personnel to complete the allocated amount of service hours of work.

21. The method of claim 12, wherein the preselect period of time comprises one year.

22. The method of claim 12, wherein the at least one preselect organization comprises one or more of a plurality of preselect charitable organizations, and wherein the service hours that are bid comprise volunteer work hours that a bidder will work performing volunteer work for the one or more of the plurality of preselect charitable organizations within the preselect period of time.

23. The method of claim 12, further comprising the step of:
if the respective highest bidder does not complete the highest amount of service hours bid in the preselect period of time,
allowing the respective highest bidder to buy-out remaining hours from its highest amount of service hours bid for which work has not been performed in order to complete the highest amount of service hours of work bid,
wherein the buy-out includes paying a cash value determined for the remaining hours.

24. A method of conducting an auction comprising the steps of:
providing an auction item upon which bidders may bid;
accepting bids from bidders on the auction item, wherein the bids comprise amounts of service hours that a bidder will work for at least one preselect organization within a preselect period of time;
awarding the auction item to the bidder that bid the highest amount of service hours;
contracting with the highest bidder, wherein the highest bidder assumes a contractual obligation to perform the highest amount of service hours of work bid within the preselect period of time, wherein the contractual obligation includes a financial penalty;
presenting the auction item to the highest bidder; and
assessing the financial penalty against if the highest bidder does not complete the highest amount of service hours of work bid within the preselect period of time.
